(19) United States
(12) Patent Application Publication
(10) Pub. No.: US 2024/0279444 A1
(43) Pub. Date: Aug. 22, 2024

(54) RUBBER MIXTURES CONTAINING POLYETHYLENEIMINE

(71) Applicant: LANXESS Deutschland GmbH, Cologne (DE)

(72) Inventors: Cristian Oprisoni, Oftersheim (DE); Antonia Albers, Cologne (DE)

(73) Assignee: LANXESS Deutschland GmbH, Cologne (DE)

(21) Appl. No.: 18/570,129

(22) PCT Filed: Jun. 27, 2022
(86) PCT No.: PCT/EP2022/067479

§ 371 Date: Dec. 14, 2023

(30) Foreign Application Priority Data
Jun. 30, 2021 (EP) 21182922.1

(51) Int. Cl. C08L 11/00

(52) U.S. Cl. CPC C08L 11/00

(57) ABSTRACT

The invention relates to novel rubber mixtures based on polychloroprene rubber and polyethyleneimine, to the production and use thereof and to the vulcanizates obtainable thereby.

The invention relates to novel rubber mixtures based on polychloroprene rubber and polyethyleneimine, to processes for the production thereof, to the use thereof for production of rubber vulcanizates by vulcanization and to moulded articles obtainable therefrom, in particular in the form of technical vulcanizates such as for example hoses, cable sheaths or belts.

Polychloroprenes are valuable rubbers that are used in many fields.

It is known to crosslink polychloroprene (CR) using certain crosslinking agents during vulcanization in order thus to improve the properties of the vulcanizate, for example mechanical properties or reversion stability.

It has long been common practice to use ethylene thiourea (ETU) as a crosslinking agent. However, ethylene thiourea is classified by the European Chemicals Agency (ECHA) as toxicologically problematic for some applications.

3-methylthiazolidine-2-thione (MTT) is also used as a crosslinker as an alternative to ethylene thiourea (ETU). The disadvantage is a deterioration in the mechanical properties compared to ETU as well as a shortening of the Mooney Scorch times in some chloroprene types. This disadvantage compared to ETU increases with increasing vulcanization temperatures above values of 180° C. to 200° C.

WO 2016/030469 discloses rubber mixtures which are substantially guanidine-free. The rapidly crosslinking but toxicologically problematic secondary accelerator guanidine was replaced by polyethyleneimine there. Especially in natural rubbers polyethyleneimine is employed there in conjunction with sulfur, sulfenamides and mercaptobenzothiazoles.

The crosslinking of rubbers with sulfur accelerator systems generally provides the advantage that, through use of different accelerators and combinations thereof, processing and product properties can be varied over wide ranges, for example adjustment of induction period (scorch time, which should ideally not be too short) and reaction rate which is preferably high, thus leading to a short complete vulcanization time. So-called secondary accelerators can be added to the rubber mixtures in order to regulate induction time and vulcanization time.

It was an object of the present invention to provide rubber mixtures based on polychloroprene (CR) and toxicologically unconcerning crosslinking agents.

It has been found that rubber mixtures based on polychloroprene (CR) and polyethyleneimine as crosslinking agents overcome the abovementioned disadvantages.

The rubber mixtures according to the invention surprisingly also exhibit improved physical stability with respect to changes in the vulcanization temperature. In addition, the vulcanizates produced from the rubber mixtures according to the invention feature improved ageing stability with respect to the influence of oxidants such as ozone or oxygen.

The present invention therefore relates to rubber mixtures containing at least one polychloroprene rubber (CR) and at least one polyethyleneimine.

The unit “phr” hereinbelow stands for parts by weight based on 100 parts by weight of the total amount of polychloroprene rubber present in the rubber mixture.

The rubber mixtures according to the invention generally contain polyethyleneimine in an amount of 0.01 to 20 phr, preferably of 0.05 to 15 phr, particularly preferably of 0.5 to 10 phr, very particularly preferably of 1 to 8 phr and in particular of 2 to 6 phr.

The rubber mixtures according to the invention contain at least one polychloroprene rubber (CR).

Polychloroprene rubber (CR) and the production thereof has long been known. It is a polymer based on 2-chloro-1,3-butadiene (chloroprene) which is obtainable by emulsion polymerization.

The rubber mixtures according to the invention may in principle contain all commonly used polychloroprene rubbers.

The commercially available polychloroprene rubber types differ in terms of their structure and properties. Among the so-called universal types a distinction is made, on account of the regulator used in polymerization, between mercaptan-modified and xanthate-modified types. These two types exist as uncrosslinked and as precrosslinked variants. Sulfur-modified CR types are also available. In addition, the different polychloroprene types are characterized especially in terms of their Mooney viscosities (ML (1+4), 100° C.) and their crystallization rates.

The rubber mixtures according to the invention preferably contain at least one polychloroprene rubber from the group of mercaptan- or xanthate-modified polychloroprene rubbers.

Mercaptan- and xanthate-modified polychloroprene rubbers are available as commercial products, for example under the trade name Baypren® (commercial product of Arlanxeo).

Mercaptan-modified polychloroprene rubbers are typically produced by emulsion polymerization of chloroprene in the presence of n-dodecylmercaptan. Xanthate-modified polychloroprene rubbers are typically produced by emulsion polymerization of chloroprene in the presence of xanthogen disulfides.

It is preferable when the rubber mixtures according to the invention contain at least one mercaptan-modified polychloroprene rubber having Mooney viscosities (ML (1+4), 100° C.) between 35 and 50 MU (“Mooney Units”) and very slow to intermediate crystallization rates and/or at least one mercaptan-modified polychloroprene rubber having a Mooney viscosity between 90 and 120 MU and an intermediate crystallization rate.

The mercaptan-modified polychloroprene rubbers which have Mooney viscosities (ML (1+4), 100° C.) between 35 and 50 MU and very slow to intermediate crystallization rates and are preferred according to the invention are available for example as commercial products of Arlanxeo under the designations Baypren® 110, Baypren® 112, Baypren® 210 and Baypren® 211. The mercaptan-modified polychloroprene rubbers which have a Mooney viscosity between 90 and 120 MU and an intermediate crystallization rate and are likewise preferred according to the invention are available for example as commercial products of Arlanxeo under the designation Baypren® 230.

The rubber mixtures according to the invention preferably contain at least one mercaptan-modified polychloroprene rubber having a molar mass distribution (Mw/Mn) in the range from 2 to 3, an average molar mass (Mw) between 4·10⁵ and 1.3·10⁶ g/mol and a Mooney viscosity between 35 and 120 MU.

The polychloroprenes present in the rubber mixtures according to the invention may have different 1,4-trans contents. This is preferably between 88% and 94%.

The rubber mixtures according to the invention contain at least one polyethyleneimine. The polyethyleneimines (PEI) present in the rubber mixtures according to the invention are preferably homopolymer(s) of ethyleneimine/copolymer(s) of ethyleneimine and one or more comonomers, wherein in the copolymers the proportion of ethyleneimine-derived repeating units, in each case based on the total mass of the polymer, is at least 50% by weight, preferably at least 80% by weight, more preferably at least 90% by weight, particularly preferably at least 95% by weight and very particularly preferably at least 98% by weight. The term polyethyleneimine also comprehends mixtures of homo- and/or copolymers of ethyleneimine, for example with different molecular weights, degrees of branching, comonomers etc.

Such homo- or copolymers typically have a weight-average molecular weight Mw greater than 200, preferably of 300 to 3,000,000, particularly preferably from 400 to 800,000, very particularly preferably from 500 to 100,000, more preferably from 600 to 30,000 and most preferably from 700 to 7000.

The polyethyleneimines present in the inventive rubber mixtures may have a linear or branched structure and mixtures of linear and branched polyethyleneimines may also be employed.

In a preferred embodiment polyethyleneimines having a branched structure having not only primary but also secondary and tertiary amino groups are employed.

It is preferable when the rubber mixtures according to the invention contain ethylenediamine-ethyleneimine copolymers/polyethyleneimine homopolymers, for example those conforming to CAS numbers 25987-06-8 and 9002-98-6.

The rubber mixtures according to the invention may contain one or more fillers.

Suitable fillers in principle include all fillers known for this purpose from the prior art, wherein active or reinforcing fillers are preferred.

The rubber mixtures of the invention generally contain 0.1 to 250 phr, preferably 20 to 200 phr and particularly preferably 25 to 160 phr of at least one filler.

The rubber mixtures of the invention preferably contain at least one oxidic filler containing hydroxyl groups and/or at least one carbon black.

The content of oxidic fillers containing hydroxyl groups in the rubber mixtures according to the invention is generally 0.1 to 250 phr, preferably 1 to 200 phr, particularly preferably 5 to 180 phr and very particularly preferably 10 to 160 phr.

Suitable oxidic fillers containing hydroxyl groups preferably include those selected from the group of
silicas, especially precipitated silicas or pyrogenic silicas, having specific surface areas of 5 to 1000 m²/g, preferably 20 to 400 m²/g (BET surface area) and having primary particle sizes of 10 to 400 nm, wherein the silicas are optionally also in the form of mixed oxides with other metal oxides such as oxides of Al, Mg, Ca, Ba, Zn, Zr, Ti;
synthetic silicates, such as aluminium silicate, alkaline earth metal silicates such as magnesium or calcium silicate, having BET surface areas of 20 to 400 m²/g and primary particle sizes of 10 to 400 nm;
natural silicates, such as kaolin and other naturally occurring silicas.
   and mixtures thereof.

The oxidic fillers containing hydroxyl groups from the group of silicas that are present in the rubber mixtures according to the invention are preferably those producible for example by precipitation of solutions of silicates or flame hydrolysis of silicon halides.

It is preferable when the rubber mixtures according to the invention contain at least one oxidic filler containing hydroxyl groups from the group of silicas having a specific surface area (BET) in the range from 20 to 400 m²/g in an amount of 0.1 to 200 phr, preferably 5 to 200 phr, particularly preferably of 10 to 100 phr and very particularly preferably of 20 to 80 phr.

All BET figures relate to the specific surface area measured to DIN 66131. The reported primary particle sizes refer to values determined by scanning electron microscope.

The rubber mixtures of the invention may further contain at least one carbon black as filler.

Preference according to the invention is given to carbon blacks that are obtainable by the lamp black, furnace black or gas black method and have a specific surface area (BET) in the range from 20 to 200 m²/g, for example SAF, ISAF, IISAF, HAF, FEF or GPF carbon blacks. The rubber mixtures of the invention preferably contain at least one carbon black having a specific surface area (BET) in the range from 20 to 200 m²/g.

The rubber mixtures of the invention generally contain 0.1 to 200 phr, preferably 5 to 150 phr, particularly preferably 20 to 120 phr, of at least one carbon black.

Provided the rubber mixtures according to the invention contain carbon black and silica-based fillers as fillers the total amount of these two filler types is preferably 10 to 200 phr, particularly preferably 15 to 160 phr.

In addition to the recited fillers the rubber mixtures according to the invention may contain as a filler at least one further filler, such as for example chopped fibres made of aramid, cellulose or nanocellulose and fillers based on lignin.

The total proportion of these recited additional fillers in the rubber mixture according to the invention is typically from 0.1 to 160 phr, preferably 0.5 to 100 phr, particularly preferably 1 to 50 phr.

The rubber mixtures of the invention may contain one or more reinforcing additives.

The rubber mixtures according to the invention preferably contain at least one reinforcing additive from the group of sulfur-containing organic silanes, in particular sulfur-containing silanes containing alkoxysilyl groups and very particularly preferably sulfur-containing organic silanes containing trialkoxysilyl groups.

It is particularly preferable when the rubber mixtures according to the invention contain one or more sulfur-containing silanes from the group of bis(triethoxysilylpropyl) tetrasulfane, bis(triethoxysilylpropyl)disulfane and 3-(triethoxysilyl)-1-propanethiol.

The rubber mixtures according to the invention generally contain 1 to 20 parts by weight, preferably 2 to 15 parts by weight and particularly preferably 2 to 10 parts by weight of at least one reinforcing additive, in each case calculated as 100% active ingredient and based on 100 parts by weight of fillers altogether present in the rubber mixture.

For better meterability and/or dispersibility liquid sulfur-containing silanes may be absorbed on a carrier (dry liquid). The content of sulfur-containing silanes in these dry liquids is preferably between 30 and 70 parts by weight, preferably 40 and 60 parts by weight, per 100 parts by weight of dry liquid. In a preferred embodiment the rubber mixtures according to the invention contain 5 to 200 phr, particularly preferably 10 to 100 phr, and very particularly preferably 20 to 80 phr of at least one oxidic filler containing hydroxyl groups from the group of silicas and 1.0 to 20 phr, preferably 5 to 15 phr and particularly preferably 2 to 10 phr of at least one reinforcing additive from the group of sulfur-containing organic silanes, particularly preferably sulfur-containing organic silanes containing alkoxysilyl groups and very particularly preferably sulfur-containing organic silanes containing trialkoxysilyl groups.

The rubber mixtures according to the invention may contain one or more crosslinkers.

The vulcanization of polychloroprene rubbers especially employs metal oxides to promote crosslinking and to neutralize hydrogen chloride gas formed during the crosslinking reaction. Suitable metal oxides in principle include magnesium oxide, zinc oxide, lead oxide and mixtures thereof.

The rubber mixtures according to the invention preferably contain at least one crosslinker from the group of metal oxides, in particular magnesium oxide and/or zinc oxide.

The rubber mixtures according to the invention generally contain 0.1 to 10 phr, preferably 0.1 to 8 phr and particularly preferably 0.1 to 5 phr of at least one metal oxide.

The rubber mixtures according to the invention may contain one or more vulcanization accelerators or vulcanization retarders.

These are vulcanization accelerators or retarders from the group of mercaptobenzothiazoles, mercaptobenzoimidazoles, thiazolesulfenamides, thiurams, thiocarbamates, tolyltriazoles, xanthates and thiophosphates.

The rubber mixtures according to the invention generally contain 0 to 10 phr, preferably 0 to 8 phr and particularly preferably 0 to 5 phr of at least one vulcanization accelerator or retarder.

The rubber mixtures of the invention may further contain one or more rubber auxiliaries.

Suitable rubber auxiliaries include for example adhesion systems, ageing inhibitors, heat stabilizers, light protectants, antioxidants, in particular antiozonants, flame retardants, processing aids, impact strength improvers, factices, plasticizers, tackifiers, blowing agents, dyes, pigments, waxes, extenders, organic acids, retarders, activators and antireversion agents.

These rubber auxiliaries may be added to the rubber mixtures according to the invention in the amounts which are customary for these auxiliaries and are also guided by the end use of the vulcanizates produced therefrom. Customary amounts are, for example, 0.1 to 30 phr.

Preferably employed ageing inhibitors include alkylated phenols, styrenated phenol, sterically hindered phenols such as 2,6-di-tert-butylphenol, 2,6-di-tert-butyl-p-cresol (BHT), 2,6-di-tert-butyl-4-ethylphenol, sterically hindered phenols containing ester groups, sterically hindered phenols containing thioether, 2,2′-methylenebis(4-methyl-6-tert-butylphenol) (BPH), and also sterically hindered thiobisphenols.

If discolouration of the rubber is unimportant it is also possible to employ aminic ageing inhibitors, for example mixtures of diaryl-p-phenylenediamines (DTPD), octylated diphenylamine (ODPA), phenyl-a-naphthylamine (PAN), phenyl-β-naphthylamine (PBN), preferably those based on phenylenediamine, e.g. N-isopropyl-N′-phenyl-p-phenylenediamine, N-1,3-dimethylbutyl-N′-phenyl-p-phenylenediamine (6PPD), N-1,4-dimethylpentyl-N′-phenyl-p-phenylenediamine (7PPD), N,N′-bis(1,4-dimethylpentyl)-p-phenylenediamine (77PD).

Further ageing inhibitors are phosphites such as tris(nonylphenyl) phosphite, polymerized 2,2,4-trimethyl-1,2-dihydroquinoline (TMQ), 2-mercaptobenzimidazole (MBI), methyl-2-mercaptobenzimidazole (MMBI), zinc methylmercaptobenzimidazole (ZMMBI), these mostly being used in combination with the above phenolic ageing inhibitors.

Ozone resistance can be improved by antioxidants such as for example N-1,3-dimethylbutyl-N′-phenyl-p-phenylenediamine (6PPD), N-1,4-dimethylpentyl-N′-phenyl-p-phenylenediamine (7PPD), N,N′-bis(1,4-dimethylpentyl)-p-phenylenediamine (77PD), enol ethers or cyclic acetals.

Processing aids should be active between the rubber particles and should counter frictional forces during mixing, plasticizing and forming. Processing aids which may be present in the rubber mixtures according to the invention include all lubricants customary for the processing of plastics, for example hydrocarbons, such as oils, paraffins and PE waxes, fatty alcohols having 6 to 20 carbon atoms, ketones, carboxylic acids, such as fatty acids and montanic acids, oxidized PE wax, metal salts of carboxylic acids, carboxamides and carboxylic esters, for example with the alcohols ethanol, fatty alcohols, glycerol, ethanediol, pentaerythritol and long-chain carboxylic acids as the acid component.

To reduce flammability and to reduce smoke evolution on combustion the rubber mixture composition according to the invention may also comprise flame retardants. Examples of compounds used for this purpose include antimony trioxide, phosphoric esters, chloroparaffin, aluminium hydroxide, boron compounds, zinc compounds, molybdenum trioxide, ferrocene, calcium carbonate and magnesium carbonate.

Further plastics may also be added to the rubber mixture according to the invention prior to the crosslinking, these acting for example as polymeric processing aids or impact modifiers. These plastics are preferably selected from the group consisting of homo- and copolymers based on ethylene, propylene, butadiene, styrene, vinyl acetate, vinyl chloride, glycidyl acrylate, glycidyl methacrylate, acrylates and methacrylates having alcohol components of branched or unbranched C1 to C10 alcohols, particular preference being given to polyacrylates having identical or different alcohol radicals from the group of C4 to C8 alcohols, in particular of butanol, hexanol, octanol and 2-ethylhexanol, polymethylmethacrylate, methyl methacrylate-butyl acrylate copolymers, methyl methacrylate-butyl methacrylate copolymers, ethylene-vinyl acetate copolymers, chlorinated polyethylene, ethylene-propylene copolymers, ethylene-propylene-diene copolymers.

Known adhesion systems are based on resorcinol, formaldehyde and silica, the so-called RFS direct adhesion systems. These direct adhesion systems may be used in any desired amount of the rubber mixture according to the invention, at any point in time during incorporation into the rubber mixture according to the invention.

Suitable formaldehyde donors include not only hexamethylenetetramine but also methylolamine derivatives. A possible adhesion improvement is achieved by addition of components capable of synthetic resin formation such as phenol and/or amines and aldehydes or aldehyde-eliminating compounds to the known rubber mixtures. Compounds widely used as resin-forming components in rubber adhesion mixtures are resorcinol and hexamethylenetetramine (HEXA) (GB Patent 801 928, FR Patent 1 021 959), optionally in combination with silica filler (German Auslegeschrift Patent 1 078 320).

Preference is given to rubber mixtures according to the invention containing
at least one polychloroprene rubber having a molar mass distribution Mw/Mn in the range from 2 to 3, an average molar mass (Mw) between 4·10⁵ and 1.3·10⁶ g/mol and a Mooney viscosity between 35 and 120 MU,
0.05 to 15 phr of at least one polyethyleneimine,
5 to 200 phr of at least one silica, in particular having a specific surface area (BET) of 5 to 1000, preferably 20 to 400, m²/g and having primary particle sizes of 100 to 400 nm, and/or
5 to 150 phr of at least one carbon black, in particular having a specific surface area (BET) in the range from 20 to 200 m²/g.

Particular preference is given to rubber mixtures of the invention containing
at least one chloroprene rubber having a molar mass distribution Mw/Mn in the range from 2 to 3, an average molar mass (Mw) between 4·10⁵ and 1.3·10⁶ g/mol and a Mooney viscosity between 35 and 120 MU,
1 0.5 to 10 phr of at least one polyethyleneimine,
10 to 100 phr of at least one silica, in particular having a specific surface area (BET) of 5 to 1000, preferably 20 to 400, m²/g and having primary particle sizes of 100 to 400 nm, and/or
20 to 120 phr of at least one carbon black, especially having a specific surface area (BET) in the range from 20 to 200 m²/g,
0.1 to 5 phr of at least one crosslinker, especially from the group of metal oxides,
2 to 10 parts by weight of at least one reinforcing additive, in particular from the group of sulfur-containing silanes, based on 100 parts by weight of fillers altogether present in the rubber mixture.

The present invention further provides a process for producing the rubber mixtures according to the invention, characterized in that it comprises intermixing at least one polychloroprene rubber and at least one polyethyleneimine, optionally in the presence of at least one filler, optionally at least one crosslinker, optionally at least one vulcanization accelerator or retarder, optionally at least one reinforcing additive and optionally one or more of the abovementioned rubber auxiliaries in the general and preferred amounts recited for these additives at a temperature in the range from 40° C. to 200° C., particularly preferably from 70° C. to 130° C.

The production of the rubber mixtures according to the invention is carried out in customary fashion in known mixing apparatuses, such as rollers, internal mixers, downstream roller mills and mixing extruders at shear rates of 1 to 1000 sec⁻¹, preferably of 1 to 100 sec⁻¹.

It is preferable when the addition of polyethyleneimine is carried out toward the end of the mixing process at lower temperatures in the range from 40° C. to 100° C., typically together with the vulcanization accelerators or retarders.

The present invention further relates to a process for producing rubber vulcanizates by heating a rubber mixture according to the invention at melt temperatures of 150° C. to 280° C., preferably at 170° C. to 240° C.

The process for producing the rubber vulcanizates according to the invention may be performed over a wide pressure range, preferably at a pressure in the range from 1 to 200 bar.

The present invention further provides rubber vulcanizates obtainable by vulcanization of a rubber mixture according to the invention.

The vulcanization of the rubber mixture according to the invention may be carried out using a press, by injection moulding or by salt bath vulcanization.

The heating of the rubber mixture to produce the vulcanizates according to the invention is typically carried out by means of a microwave, by hot air, by hot steam, in a salt bath or in an autoclave.

The present invention further provides rubber vulcanizates obtainable by vulcanization of a rubber mixture according to the invention.

The vulcanizates according to the invention are suitable for producing a wide variety of rubber products, in particular for producing technical rubber articles such as hoses, moulded articles, cables and conduits, belts, profiles, conveyor belts, damping elements, coverings for rollers and rubberized fabrics.

The rubber mixture according to the invention may further be used for producing foams. This comprises adding chemical or physical blowing agents to a rubber mixture according to the invention. Contemplated chemical blowing agents include all substances known for this purpose, for example azodicarbonamide, p-toluenesulfonyl hydrazide, 4,4′-oxybis(benzenesulfohydrazide), p-toluenesulfonyl semicarbazide, 5-phenyltetrazole and also mixtures comprising these substances. Examples of suitable physical blowing agents include carbon dioxide and halogenated hydrocarbons.

The present invention further provides moulded articles, in particular technical rubber articles such as hoses, cables, conduits, belts, profiles, conveyor belts, damping elements, coverings for rollers and rubberized fabrics and also foams containing a rubber vulcanizate according to the invention.

The invention is to be elucidated by the examples that follow, but without being limited thereto.

### EXEMPLARY EMBODIMENTS

List of employed products and their manufacturers

| | | Manufacturer/ |
|---|---|---|
| Trade name | Description | distributor |
| BAYPREN ® 211 | Polychloroprene (CR) | Arlanxeo |
| MOONEY 35-43 | | |
| REGAL ® SRF/N772 | Carbon black | Cabot |
| | | Corporation |
| PALMERA ® A9818 | Stearic acid | KLK Oleo |
| RHENOCURE ® | Ethylene thiourea | Lanxess |
| NPV/C | (ETU) | Deutschland GmbH |
| RHENOCURE ® DR/S | Polyethyleneimine | Lanxess |
| | CAS No.: 9002-98-6 | Deutschland GmbH |
| RHENOCURE ® | 3-methylthiazolidine-2- | Lanxess |
| CRV/LG | thione (MTT) | Deutschland GmbH |
| RHENOFIT ® D/A | Magnesium oxide | Lanxess |
| | | Deutschland GmbH |
| VULKANOX ® | N-1,3-dimethylbutyl-N- | Lanxess |
| 4020/LG | phenyl-p- | Deutschland GmbH |
| | phenylenediamine | |
| ROTSIEGEL zinc white | Zinc oxide | Grillo Zinkoxid |
| | | GmbH |

### Production of the Rubber Vulcanizates According to the Invention

Vulcanizates were produced from the rubber formulations of Example 1 and of the reference examples Comparative Example 1 to Comparative Example 3 shown in Table 1. This comprised mixing the constituents reported in Table 1 for Example 1 and the reference examples in the amounts reported therein (all in “parts per 100 rubber” (phr)) in each case in a mixing process as described below.

The polyethyleneimine (RHENOCURE® DR/S) from Example 1 was replaced by ethylene thiourea (ETU) (as RHENOCURE® NPV/C) in the reference example Comparative Example 2 and by 3-methylthiazolidine-2-thione (MTT) (RHENOCURE® CRV/LG) in the reference example Comparative Example 3. The reference example Comparative Example 1 was carried out without addition of a crosslinking agent.

In each case in a first mixing step the polychloroprene rubber BAYPREN® 211 was initially charged in a kneader (GK 1.5) and the additives REGAL® SRF/N772, PALMERA® A9818 and VULKANOX® 4020/LG were added at a temperature of about 40° C. and about 40 revolutions per second. The mixture was mixed at a temperature of 100° C. for about 3 minutes.

Subsequently, in a second mixing step the rubber mixture was supplied to a temperature-controlled roller and the following additives added and incorporated into the rubber mixture: ROTSIEGEL zinc oxide, RHENOFIT® D/A and in Example 1 RHENOCURE® DR/S, in Comparative Example 2 RHENOCURE® NPV/C and in Comparative Example 3 RHENOCURE® CRV. The roller temperature was between 30° C. and 50° C.

The resulting rubber mixtures were subsequently subjected to complete vulcanization and rolled into test plaques at 180° C. and 200° C. respectively.

These test plaques were used for the subsequent performance tests as specified below.

TABLE 1
Formulations

| Examples | Ex. 1 | Comp. 1 | Comp. 2 | Comp. 3 |
|---|---|---|---|---|
| BAYPREN ® 211 MOONEY | 100 | 100 | 100 | 100 |
| 35-43 | | | | |
| REGAL ® SRF/N772 | 30 | 30 | 30 | 30 |
| PALMERA ® A9818 | 0.5 | 0.5 | 0.5 | 0.5 |
| VULKANOX ® 4020/LG | 2 | 2 | 2 | 2 |
| RHENOFIT ® D/A | 4 | 4 | 4 | 4 |
| ROTSIEGEL zinc white | 5 | 5 | 5 | 5 |
| RHENOCURE ® NPV/C | | | 1 | |
| RHENOCURE ® CRV/LG | | | | 1.7 |
| RHENOCURE ® DR/S | 4 | | | |

### Technical Tests

The rubber mixtures and vulcanizates produced were subjected to the technical tests set out below. The determined values are reported in Tables 2 to 4.

### Determination of Properties of Rubber Mixture/Vulcanizates

### Measurement of Mooney Viscosity:

Determination was effected by means of a shearing disc viscometer in accordance with ASTM D 1646. The viscosity may be determined directly from the force with which rubbers (and rubber mixtures) resist processing. In the Mooney shearing disc viscometer, a fluted disc is surrounded, above and below, by test substance and is rotated at about two revolutions per minute in a heatable chamber. The force required therefor is measured as torque and corresponds to the respective viscosity. The sample is generally preheated to 100° C. for one minute; the measurement takes a further 4 minutes over which time the temperature is kept constant. The viscosity is reported together with the respective test conditions, for example ML (1+4) 100° C. (Mooney viscosity, rotor size L, preheat time and test time in minutes, test temperature).

### Rheometer (Vulcameter):

The MDR (moving die rheometer) vulcanization profile and analytical data associated therewith are measured in an MDR 2000 Monsanto rheometer in accordance with ASTM D5289-95. The time at which 95% of the rubber has been crosslinked is determined as the complete vulcanization time. The mixtures were heated at 180° C. up to a conversion of 95%. At 200° C. the vulcanization time was 20 minutes.

### Breaking Elongation, Tensile Strength, 50, 100 and 300 Modulus:

These measurements were carried out according to DIN 53504 (tensile test, rod S2, 5-plicate measurement).

### Hardness:

Measurement of Shore hardness (Shore A) according to DIN 53505 at 23° C. (3-plicate measurement).

### Rebound Elasticity:

Measurement of rebound elasticity at 23° C. (3-plicate measurement) according to DIN 53512.

### Compression Set (CS):

Measurement of compression set after 72 h at 100° C. Measurement carried out according to DIN ISO 815.

TABLE 2
Physical properties

| | | Comp. | Comp. | Comp. | Exam- |
|---|---|---|---|---|---|
| | | 1 | 2 | 3 | ple 1 |
| Delta S′ (MDR200) | dNm | | 16.6 | 17.0 | 15.0 |
| 10% conversion time | [sec] | | 27 | 23 | 31 |
| (MDR200) | | | | | |
| 90% conversion time | [sec] | | 130 | 122 | 519 |
| (MDR200) | | | | | |
| Delta S′ (MDR180) | dNm | 11.4 | 17.3 | 16.2 | 15.3 |
| 10% conversion time | [sec] | 94 | 42 | 32 | 50 |
| (MDR180) | | | | | |
| 90% conversion time | [sec] | 1530 | 266 | 118 | 980 |
| (MDR180) | | | | | |

Vulcanization at 200° C.

| | | | | | |
|---|---|---|---|---|---|
| Average hardness | Shore A | 57.3 | 61.3 | 65.2 | 65.8 |
| Average rebound | % | 53.8 | 57.5 | 61.3 | 57.9 |
| 50 modulus | MPa | 1.7 | 1.9 | 1.5 | 1.8 |
| 100 modulus | MPa | 3.1 | 3.9 | 3.0 | 3.9 |
| 200 modulus | MPa | 7.7 | 10.2 | 10.9 | 10.6 |
| 300 modulus | MPa | 14.2 | — | — | 16.7 |
| Tensile breaking | % | 449 | 255 | 200 | 262 |
| elongation | | | | | |
| Tensile strength | MPa | 24.5 | 15.8 | 10.1 | 14.9 |
| CS 72 h at 100° C. | % | 22.8 | 12.0 | 14.1 | 17.9 |

Vulcanization at 180° C.

| | | | | | |
|---|---|---|---|---|---|
| Average hardness | Shore A | 51.4 | 47.1 | 61.5 | 61.8 |
| Average rebound | % | 55.1 | 59.4 | 60.5 | 58.2 |
| 50 modulus | MPa | 1.2 | 1.6 | 2.1 | 1.9 |
| 100 modulus | MPa | 2 | 3 | 4.2 | 4 |
| 200 modulus | MPa | 5.2 | 8.7 | 11.1 | 10.8 |
| 300 modulus | MPa | 10.7 | 18.2 | 19.5 | 17.2 |
| Tensile breaking | % | 574 | 340 | 293 | 354 |
| elongation | | | | | |
| Tensile strength | MPa | 26.5 | 22.3 | 19.1 | 19.9 |
| CS 72 h at 100° C. | % | 28.4 | 15.9 | 23.9 | 21.5 |

TABLE 2
Change in physical properties in [%] caused
by different heating temperatures during complete
vulcanization (180° C. vs 200° C.)

| | | Comp. | Comp. | Comp. | Exam- |
|---|---|---|---|---|---|
| | | 1 | 2 | 3 | ple 1 |
| 50 modulus | MPa | 29% | 16% | 40% | 6% |
| 100 modulus | MPa | 35% | 23% | 40% | 3% |
| 200 modulus | MPa | 32% | 19% | 8% | 2% |
| 300 modulus | MPa | 25% | | | 3% |
| Tensile breaking | % | 28% | 33% | 47% | 35% |
| elongation | | | | | |
| Tensile strength | MPa | 8% | 41% | 89% | 34% |
| Average hardness | Shore A | 10% | 23% | 6% | 6% |
| Average rebound | % | 2% | 3% | 1% | 0% |
| CS 72 h at 100° C. | % | 25% | 32% | 69% | 20% |

Vulcanizates were produced from the reference examples Comparative Example 1, Comparative Example 2 and Comparative Example 3 and also from Inventive Example 1 in each case at vulcanization temperatures of 180° C. and 200° C.

A comparison of the determined values for Inventive Example 1 with the values for reference examples Comparative Example 1, Comparative Example 2 and Comparative Example 3 shows that, while the crosslinking rate (90% conversion time used as measure) is slower with PEI than with ETU or MTT at both 180° C. and 200° C. (Examples 2 and 3, Table 2), comparable delta-torque values (delta S′) are ultimately achieved, thus indicating a comparable level of crosslinking. By contrast, the reference example Comparative Example 1 without additional crosslinking chemicals shows a significantly lower delta S′ value and thus a lower crosslinking density of the vulcanizate.

Tensile tests were performed for all vulcanizates. Here too, the comparable values for 200 modulus and 300 modulus indicate a comparable crosslinking density of reference examples Comparative Example 2 and Comparative Example 3 and Inventive Example 1. And here too, the reference example of Comparative Example 1 appears to have a much lower degree of crosslinking than Comparative Examples 2 and 3 and Example 1.

The tensile breaking elongation and tensile strength of Example 1 shows good values compared to Comparative Examples 2 and 3. As expected the values for Comparative Example 1 are at a markedly higher level due to the lower degree of crosslinking.

The compression set values (72 h at 100° C.) are better in Example 1, heated at 200° C., than Comparative Examples 1 and 3 but slightly poorer than Comparative Example 2.

The marked advantage of Example 1 relative to the comparative examples is apparent from the stability to the heating temperature illustrated by the percentage change in the physical properties as reported in Table 2. Here, Example 1 shows a markedly smaller change in values compared to Comparative Examples 1 to 3.

TABLE 4
Physical properties after ageing (7 days at 100° C.).

| Comp. | Comp. | Comp. | Exam- |
|---|---|---|---|
| 1 | 2 | 3 | ple 1 |

Vulcanization at 180° C.

| | | | | | |
|---|---|---|---|---|---|
| Average hardness | Shore A | 64 | 64 | 65 | 67 |
| 50 modulus | MPa | 2.2 | 2 | 2.4 | 2.5 |
| 100 modulus | MPa | 4.4 | 3.9 | 4.5 | 5.2 |
| 200 modulus | MPa | 11.4 | 10.9 | 12.2 | 12.7 |
| 300 modulus | MPa | 20.2 | 20.8 | — | 19.4 |
| Tensile breaking | % | 337 | 311 | 289 | 302 |
| elongation | | | | | |
| Tensile strength | MPa | 22.7 | 22 | 21.4 | 20.2 |
| Average rebound | % | 56.7 | 58.5 | 58.2 | 58.3 |

Vulcanization at 200° C.

| | | | | | |
|---|---|---|---|---|---|
| Average hardness | Shore A | 62.9 | 63.6 | 68.0 | 67.5 |
| 50 modulus | MPa | 2.2 | 2.3 | 2 | 2 |
| 100 modulus | MPa | 4.4 | 4.6 | 3.8 | 4.3 |
| 200 modulus | MPa | 11.4 | 12.4 | 10.7 | 11.3 |
| 300 modulus | MPa | 20.9 | — | — | — |
| Tensile breaking | % | 328 | 283 | 192 | 283 |
| elongation | | | | | |
| Tensile strength | MPa | 23 | 21.4 | 10.5 | 17.6 |
| Average rebound | % | 55.5 | 57.3 | 61.5 | 59.0 |

TABLE 5
Change in physical properties [%] after ageing (7 days at 100° C.).

| | | | |
|---|---|---|---|
| Comp. 1 | Comp. 2 | Comp. 3 | Example 1 |

Vulcanization at 180° C.

| | | | | | |
|---|---|---|---|---|---|
| Δ average hardness | % | 24% | 36% | 6% | 8% |
| Δ 50 modulus | % | 83% | 25% | 14% | 32% |
| Δ 100 modulus | % | 120% | 30% | 7% | 30% |
| Δ 200 modulus | % | 117% | 24% | 10% | 18% |
| Δ 300 modulus | % | 89% | 14% | — | 13% |
| Δ tensile breaking | % | −41% | −9% | −1% | −15% |
| elongation | | | | | |
| Δ tensile strength | % | −14% | −1% | 12% | 2% |
| Δ average rebound | % | 3% | −2% | −4% | 0% |

Vulcanization at 200° C.

| | | | | | |
|---|---|---|---|---|---|
| Δ average hardness | % | 10% | 4% | 4% | 3% |
| Δ 50 modulus | % | 29% | 21% | 33% | 11% |
| Δ 100 modulus | % | 42% | 18% | 27% | 10% |
| Δ 200 modulus | % | 48% | 14% | 5% | 7% |
| Δ 300 modulus | % | 47% | — | — | — |
| Δ tensile breaking | % | −27% | 11% | −4% | 8% |
| elongation | | | | | |
| Δ tensile strength | % | −6% | 35% | 4% | 18% |
| Δ average rebound | % | 3% | 0% | 0% | 2% |

As expected, storage of the rubber vulcanizates at 100° C. in air for 7 days results in stiffening of the mixtures. Vulcanizates of Example 1 show a particularly high stability to ageing at a vulcanization temperature of 200° C. compared to the 3 comparative examples as illustrated by the change in physical properties, in particular by the relatively small change in the modulus values (see table 5).

1. A rubber mixture, comprising at least one polychloroprene rubber (CR) and at least one polyethyleneimine.

2. The rubber mixture according to claim 1, wherein the at least one polyethyleneimine is in an amount of 0.01 to 20 phr.

3. The rubber mixture according to claim 1, wherein the polychloroprene rubber has a molar mass distribution Mw/Mn in the range from 2 to 3 and an average molar mass (Mw) between 4·10⁵ and 1.3·10⁶ g/mol.

4. The rubber mixture according to claim 1, comprising at least one oxidic filler containing hydroxyl groups in an amount of 0.1 to 250 phr.

5. The rubber mixture according to claim 1, comprising at least one carbon black in an amount of 0.1 to 200 phr.

6. The rubber mixture according to claim 1, comprising at least one crosslinker from the group of metal oxides.

7. The rubber mixture according to claim 1, comprising at least one reinforcing additive from the group of sulfur-containing organic silanes, wherein the sulfur-containing silanes containing alkoxysilyl groups.

8. The rubber mixture according to claim 1, comprising at least one vulcanization accelerator from the group of mercaptobenzothiazoles, mercaptobenzoimidazoles, thiazolesulfenamides, thiurams, thiocarbamates, tolyltriazoles, xanthates and thiophosphates.

9. The rubber mixture according to claim 1, comprising at least one rubber auxiliary from the group of adhesion systems, ageing inhibitors, heat stabilizers, light protectants, antioxidants, in particular antiozonants, flame retardants, processing aids, impact strength improvers, factices, plasticizers, tackifiers, blowing agents, dyes, pigments, waxes, extenders, organic acids, retarders, activators and antireversion agents.

10. Use of polyethyleneimine as a crosslinking agent for rubber mixtures based on polychloroprene rubber.

11. A process for producing a rubber mixture according to claim 1, comprising intermixing at least one polychloroprene rubber and at least one polyethyleneimine, optionally in the presence of at least one filler at a temperature in the range from 40° C. to 200° C.

12. A rubber vulcanizate obtainable by vulcanization of a rubber mixture according to claim 1.

13. A process for producing a rubber vulcanizate, wherein at least one rubber mixture according to claim 1 is heated to a temperature in the range from 150° C. to 240° C.

14. Moulded articles, wherein the moulded articles are technical rubber articles such as hoses, cables, conduits, belts, profiles, conveyor belts, damping elements, coverings for rollers and rubberized fabrics and also foams containing a rubber vulcanizate according to claim 12.

15. The rubber mixture according to claim 1, wherein the at least one polyethyleneimine is in an amount of 0.05 to 15 phr.

16. The rubber mixture according to claim 1, wherein the at least one polyethyleneimine is in an amount of 1 to 8 phr.

17. The rubber mixture according to claim 1, wherein the at least one polyethyleneimine is in an amount of 2 to 6 phr.

18. The rubber mixture according to claim 1, comprising at least one oxidic filler containing hydroxyl groups in an amount of 10 to 160 phr.

19. The process for producing a rubber mixture according to claim 11, comprising intermixing at least one polychloroprene rubber and at least one polyethyleneimine in the presence of at least one crosslinker at a temperature in the range from 40° C. to 200° C.

20. The process for producing a rubber mixture according to claim 11, comprising intermixing at least one polychloroprene rubber and at least one polyethyleneimine in the presence of at least at least one vulcanization accelerator or retarder at a temperature in the range from 40° C. to 200° C.
